(19) United States
(12) Patent Application Publication
(10) Pub. No.: US 2026/0016831 A1
(43) Pub. Date: Jan. 15, 2026

(54) CONTROL SYSTEM, CONTROL DEVICE, CONTROL METHOD, STORAGE MEDIUM STORING CONTROL PROGRAM, AUTONOMOUS TRAVELING DEVICE

(71) Applicant: DENSO CORPORATION, Kariya-city (JP)

(72) Inventors: KEIGO FUJIMOTO, Kariya-city (JP); YUKI KATO, Kariya-city (JP)

(21) Appl. No.: 19/338,947

(22) Filed: Sep. 24, 2025

Related U.S. Application Data
(63) Continuation of application No. PCT/JP2024/007796, filed on Mar. 1, 2024.

(30) Foreign Application Priority Data
Mar. 29, 2023 (JP) 2023-054174

(51) Int. Cl. G05D 1/617; G07C 5/02

(52) U.S. Cl. CPC G05D 1/617; G07C 5/02

(57) ABSTRACT

A control system includes at least one of (i) a circuit and (ii) a processor with a memory storing computer program code executable by the processor, the at least one of the circuit and the processor configured to cause the control system to: control autonomous traveling of an autonomous traveling device in a traveling area; monitor a risk determination condition for determining an entrapment risk that the autonomous traveling device forms a situation where a peripheral monitoring target person is between the autonomous traveling device and an object present in the traveling area; and limit a drive torque for causing the autonomous traveling device to autonomously travel when the risk determination condition is satisfied.

### CROSS REFERENCE TO RELATED APPLICATIONS

The present application is a continuation application of International Patent Application No. PCT/JP2024/007796 filed on Mar. 1, 2024, which designated the U.S. and claims the benefit of priority from Japanese Patent Application No. 2023-054174 filed on Mar. 29, 2023. The entire disclosures of all of the above applications are incorporated herein by reference.

### TECHNICAL FIELD

The present disclosure relates to a technology for controlling autonomous traveling of an autonomous traveling device in a traveling area.

### BACKGROUND

As a comparative example, a technology for controlling the traveling speed of an autonomous traveling device depending on road surface conditions of the traveling area has been known.

### SUMMARY

According to an aspect of the present disclosure, a control system includes at least one of (i) a circuit and (ii) a processor with a memory storing computer program code executable by the processor, the at least one of the circuit and the processor configured to cause the control system to: control autonomous traveling of an autonomous traveling device in a traveling area; monitor a risk determination condition for determining an entrapment risk that the autonomous traveling device forms a situation where a peripheral monitoring target person is between the autonomous traveling device and an object present in the traveling area; and limit a drive torque for causing the autonomous traveling device to autonomously travel when the risk determination condition is satisfied.

### BRIEF DESCRIPTION OF THE DRAWINGS

FIG. 1 is a block diagram showing a physical configuration of a control system according to an embodiment.

FIG. 2 is a perspective view showing the appearance of an automated traveling device according to the embodiment.

FIG. 3 is a block diagram showing a configuration of an automated traveling device according to the embodiment.

FIG. 4 is a schematic perspective view illustrating map information according to the embodiment.

FIG. 5 is a block diagram showing a functional configuration of a control system according to the embodiment.

FIG. 6 is a flowchart showing a control flow according to the embodiment.

FIG. 7 is a horizontal plane view schematic diagram illustrating a risk determination condition according to the embodiment.

FIG. 8 is a horizontal plane view schematic diagram illustrating a risk determination condition according to the embodiment.

FIG. 9 is an elevation view schematic diagram illustrating a risk determination condition according to the embodiment.

FIG. 10 is an elevation view schematic diagram illustrating a risk determination condition according to the embodiment.

FIG. 11 is an elevation view schematic diagram illustrating the risk determination condition according to the embodiment.

FIG. 12 is a graph illustrating steady-state control of drive torque according to the embodiment.

FIG. 13 is a graph illustrating a limit control of the drive torque according to the embodiment.

### DETAILED DESCRIPTION

The above technology of the comparative example does not take into account the risks associated with sudden person behavior in the traveling area where the autonomous traveling device coexists with peripheral persons. For example, to prevent a person such as a child from suddenly entering between the autonomous traveling device and an object such as a wall from the peripheral area, it is necessary to control the autonomous traveling device while anticipating the risk.

An example of the present disclosure provides a control technology for an autonomous traveling device that exerts risk hedging capabilities against humans. Another example of the present disclosure provides an autonomous traveling device that is controlled to exert risk hedging capabilities against humans.

According to a first example embodiment of the present disclosure, a control system includes a processor configured to: control autonomous traveling of an autonomous traveling device in a traveling area; monitor a risk determination condition for determining an entrapment risk that the autonomous traveling device forms a situation where a peripheral monitoring target person is between the autonomous traveling device and an object present in the traveling area; and limit a drive torque for causing the autonomous traveling device to autonomously travel when the risk determination condition is satisfied.

According to a second example embodiment of the present disclosure, a control device is mountable on an autonomous traveling device, and includes a processor configured to: control autonomous traveling in a traveling area of the autonomous traveling device; monitor a risk determination condition for determining an entrapment risk that the autonomous traveling device forms a situation where a peripheral monitoring target person is between the autonomous traveling device and an object present in the traveling area; and limit a drive torque for causing the autonomous traveling device to autonomously travel when the risk determination condition is satisfied.

According to a third example embodiment of the present disclosure, a control method is executed by a processor, and includes: controlling autonomous traveling of an autonomous traveling device in a traveling area; monitoring a risk determination condition for determining an entrapment risk that the autonomous traveling device forms a situation where a peripheral monitoring target person is between the autonomous traveling device and an object present in the traveling area; and limiting a drive torque for causing the autonomous traveling device to autonomously travel when the risk determination condition is satisfied.

According to a fourth example embodiment of the present disclosure, a non-transitory computer-readable storage medium stores a control program including instructions causing a processor to: control autonomous traveling of an autonomous traveling device in a traveling area; monitor a risk determination condition for determining an entrapment risk that the autonomous traveling device forms a situation where a peripheral monitoring target person is between the autonomous traveling device and an object present in the traveling area; and limit a drive torque for causing the autonomous traveling device to autonomously travel when the risk determination condition is satisfied.

According to a fifth example embodiment of the present disclosure, an autonomous traveling device is equipped with the control device according to the second example embodiment.

According to these first to first example embodiments, the risk determination condition is monitored to determine the risk of the autonomous traveling device trapping the nearby monitoring target person between itself and the object present in the traveling area. Therefore, according to these first to first example embodiments, when the risk determination condition is satisfied, the drive torque for causing the autonomous traveling device to drive autonomously is limited. Thereby, it is possible to grasp, in advance, the entrapment risk due to sudden actions such as the monitoring target person entering between the object and the autonomous traveling device from the peripheral area, and limit the drive torque to the limit torque that prepares for the entrapment risk. Therefore, it is possible to exert risk hedging capabilities against the monitoring target person that is human.

Hereinafter, an embodiment of the present disclosure will be described with reference to the drawings.

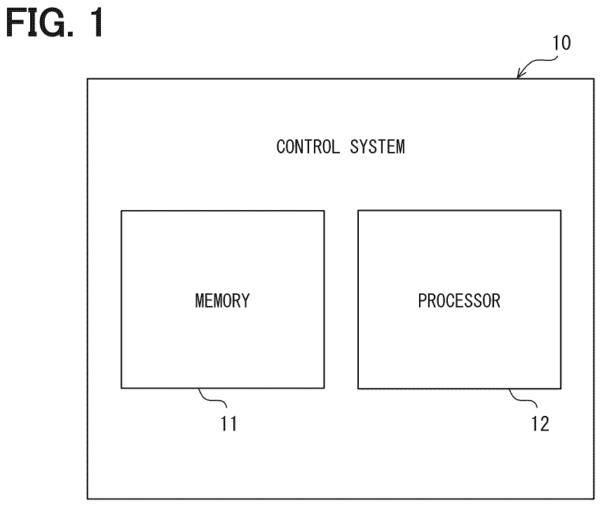

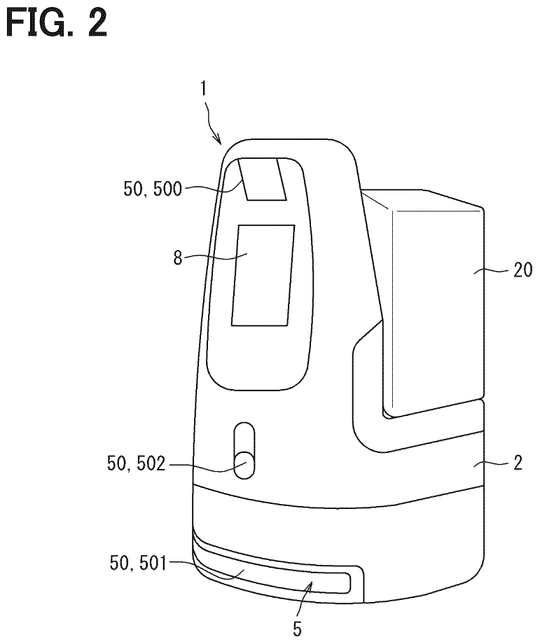

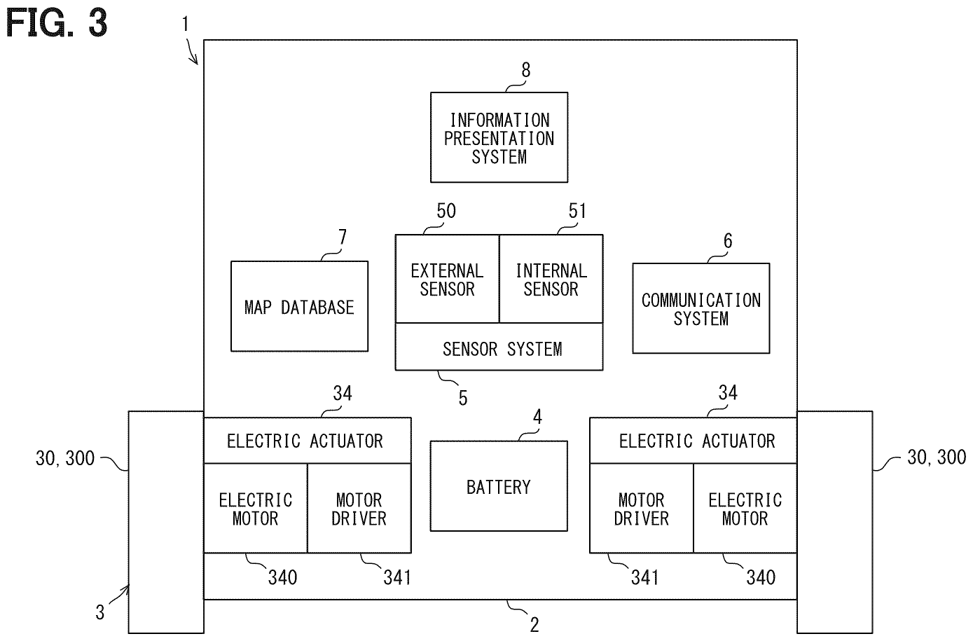

A control system 10 according to an embodiment shown in FIG. 1 controls autonomous traveling of an autonomous traveling device 1 shown in FIGS. 2 and 3 in a traveling area. The autonomous traveling device 1 is configured to perform autonomous traveling in any direction of the front, back, left and right.

The autonomous traveling device 1 may be a delivery robot that autonomously travels on traveling paths inside and outside buildings in a smart city or smart station as a traveling area, or on traveling paths (i.e., roads) on an external route as a traveling area, to deliver luggage. The autonomous traveling device 1 may be a food delivery robot that autonomously travels along a route within a restaurant or hospital as a traveling area and delivers food and drink. The autonomous traveling device 1 may be a logistics robot that autonomously travels along traveling paths inside and outside a warehouse in a logistics facility as the traveling area to transport luggage. The autonomous traveling device 1 may be a disaster support robot that autonomously travels around a disaster area as the traveling area to transport supplies or collect information. The autonomous traveling device 1 may of course be a robot other than these. Furthermore, any type of autonomous traveling device 1 may receive remote traveling assistance or traveling control from an external center.

The autonomous traveling device 1 includes a body 2, a drive system 3, a battery 4, a sensor system 5, a communication system 6, a map database 7, and an information presentation system 8. The body 2 has a hollow shape, which is made of metal, for example. The body 2 holds other components of the autonomous traveling device 1 inside or across the body 2.

The drive system 3 includes wheels 30 and an electric actuator 34. The wheels 30 are supported by the body 2. Each of the wheels 30 is rotatable independently. Of the multiple wheels 30, a pair of drive wheels 300, one on each side of the body 2, are independently driven by individual electric actuators 34. In particular, according to the present embodiment, the traveling state of the autonomous traveling device 1 switches between straight traveling and turning traveling depending on the difference in rotational speed between these drive wheels 300 (i.e., the difference in the number of rotations per unit time).

Specifically, the autonomous traveling device 1 travels straight when the rotation speed difference between the two right and left drive wheels 300 is zero or substantially zero. On the other hand, the autonomous traveling device 1 turns when the rotation speed difference between the right and left drive wheels 300 increases. The greater the rotation speed difference, the less the turning radius of the autonomous traveling device 1 is. Here, the turning radius means the distance between the vertical center line of the body 2 and the center of the turning in a planar view. The turning is a point turning when the turning radius is substantially zero. The multiple wheels 30 may include at least one driven wheel that rotates in response to the drive wheel 300.

At least one battery 4 is mounted in the body 2. The battery 4 mainly includes a storage battery such as a lithium ion battery, for example. The battery 4 stores electric power by charging from an external device and supplies the electric power to electric components in the body 2 by discharging. The battery 4 may store regenerated electric power from the electric actuators 34. The battery 4 is connected to the electric actuator 34, the sensor system 5, the communication system 6, the map database 7, and the information presentation system 8, which are the destinations of the power supply, via wire harnesses so as to supply power thereto.

A pair of electric actuators 34 are supported by the body 2. Each of the electric actuators 34, one on each side of the body 2, mainly includes a set of an electric motor 340 and a motor driver 341. The electric motors 340 in the electric actuators 34 independently rotate and drive the corresponding drive wheels 300. In each electric actuator 34, the motor driver 341 adjusts the current applied to the electric motor 340 in the same group in accordance with the current command value from the control system 10. Thereby, the output of the drive torque to the corresponding driving wheel 300 is controlled in accordance with the current command value.

Each of the electric actuator 34 may include a brake unit that applies braking to the corresponding drive wheel 300 during rotation. Each of the electric actuator 34 may include a lock unit that locks the corresponding drive wheel 300 while stopped.

The sensor system 5 acquires sensing information that can be used by the control system 10 by sensing the external and internal fields of the autonomous traveling device 1. For this purpose, the components of the sensor system 5 are mounted at various locations on the body 2. Specifically, the sensor system 5 includes an external sensor 50 and an internal sensor 51.

The external sensor 50 acquires external environment information as sensing information from the external environment that is the peripheral environment of the autonomous traveling device 1. The external sensor 50 acquires the external information by detecting an object existing in the external environment of the autonomous traveling device 1. The object detection type external sensor 50 is, for example, at least one of a camera, LiDAR (Light Detection and Ranging/Laser Imaging Detection and Ranging), radar, sonar, an impact sensor, a contact sensor, and the like.

Here, as an example of the object detection type external sensor 50 as shown in FIG. 2, a camera 502 that captures images ahead may be provided, for example, in the middle part of the autonomous traveling device 1 in the height direction as a vertical plane direction (also referred to as an elevation view direction). In addition, as the object detection type external sensor 50, a three-dimensional LiDAR 500 and a two-dimensional LiDAR 501 may be provided at the top and bottom of the autonomous traveling device 1 in the height direction, respectively. The three-dimensional LiDAR 500 scans the horizontal and vertical directions ahead, and the two-dimensional LiDAR 501 scans the horizontal direction. Here, in particular, the lower two-dimensional LIDAR 501 may be capable of detecting, for example, a child lying down on the road.

The internal sensor 51 as shown in FIG. 3 acquires internal environment information as sensing information from the internal environment of the autonomous traveling device 1. The internal sensor 51 may be a physical quantity detection type of acquiring the internal information by detecting a specific physical quantity of motion inside the autonomous traveling device 1. The internal sensor 51 of the physical quantity detection type is, for example, at least one type of sensor selected from the group consisting of a speed sensor, an acceleration sensor, a yaw rate sensor, or an inertial sensor.

When a transport box 20 is present as part of the body 2 (see the example structure in FIG. 2), the internal sensor 51 may be an internal luggage compartment detection type that acquires internal information by detecting the interior of the luggage compartment, which is the internal space of the transport box 20. The internal sensor for detecting the interior of the luggage compartment is, for example, at least one of a weight sensor, a pressure sensor, a camera, or an RFID (Radio Frequency Identifier) reader.

The communication system 6 transmits and receives communication information that can be used by the control system 10 via wireless communication between the autonomous traveling device 1 and the outside. The communication system 6 may be a positioning type sensor that acquires communication information by receiving a positioning signal from an artificial satellite of a global navigation satellite system (GNSS) present outside the autonomous traveling device 1. The positioning type communication system 6 is, for example, a GNSS receiver and the like.

The communication system 6 may be a V2X type communication system that exchanges communication information with a Vehicle to Everything (i.e., V2X) system located in the external environment of the autonomous traveling device 1. The V2X type communication system 6 is at least one of, for example, a dedicated short range communications (DSRC) communication device or a cellular V2X (C-V2X) communication device. The communication system 6 may be a terminal communication type communication system that exchanges communication information with a mobile terminal existing in the external environment of the autonomous traveling device 1. The terminal communication type communication system 6 is at least one of, for example, a Bluetooth (registered trademark) device, a Wi-Fi (registered trademark) device, or an infrared communication device.

The map database 7 stores map information usable by the control system 10. The map database 7 includes a non-transitory tangible storage medium, which is, for example, at least one type of a semiconductor memory, a magnetic medium, an optical medium, or the like. The map database 7 may be a database of a locator that estimates the self-position of the autonomous traveling device 1. The map database 7 may be a database of a planning unit that plans traveling of the autonomous traveling device 1. The map database 7 may be configured by combining multiple types of these databases.

The map database 7 acquires and stores the latest map information by, for example, communication with the external center. The map information is converted into two-dimensional or three-dimensional data as information indicating the traveling area of the autonomous traveling device 1. In particular, digital data of a high definition map may be adopted as the three-dimensional map data.

The map information may include, for example, road information that indicates at least one of position coordinates, size, shape, or road surface condition of the road. The map information may include, for example, stationary object information that indicates at least one of the position coordinates, size, shape, or the like of buildings, structures, and plants along the travel route. The map information may include, for example, road marking information that indicates at least one of the position coordinates, size, shape, or the like of signs, dividing lines, and traffic lights attached to roads serving as traveling paths.

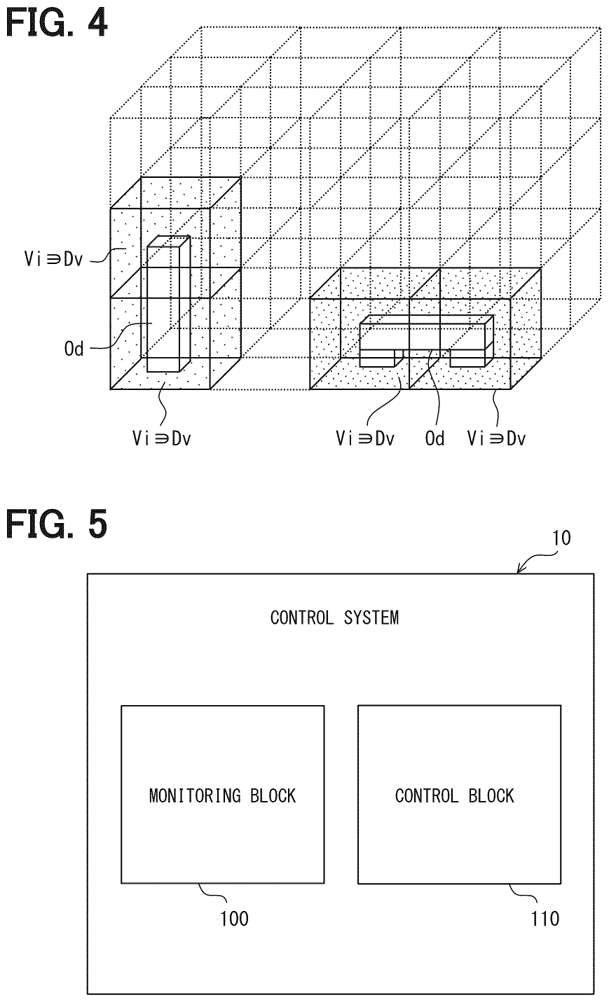

Here, the map information may be acquired as data downloaded to the map database 7 via the communication system 6 from an infrastructure database in an infrastructure system such as an external center, for example. In this case, the map information may be acquired as point group data Dv of, for example, an object Od, each associated with an individual spatial ID, for example, for multiple three-dimensional voxels Vi (i.e., three-dimensional grids) obtained by virtually dividing the traveling area into a three-dimensional array as shown in FIG. 4, or for multiple two-dimensional grids obtained by virtually dividing the traveling area into two-dimensional tiles.

The information presentation system 8 shown in FIG. 3 presents notification information to people in the periphery of the autonomous traveling device 1. The information presentation system 8 may present notification information by stimulating the vision of people in the periphery. The visual stimulation type information presentation system 8 is at least one of a monitor unit or a light emitting unit, for example. The information presentation system 8 may present the notification information by stimulating the auditory of periphery people. The auditory stimulation type information presentation system 8 is, for example, at least one of a speaker, a buzzer, a vibration unit, and the like.

The control system 10 shown in FIG. 1 controls the autonomous traveling of the autonomous traveling device 1 by following a traveling trajectory in a traveling schedule while recognizing the external environment and the device's own position. Therefore, the control system 10 includes at least one dedicated computer, including a computer mounted on the body 2. The dedicated computer constituting the control system 10 is connected to the electric actuators 34 shown in FIG. 3, the battery 4, the sensor system 5, the communication system 6, the map database 7, and the information presentation system 8 through, for example, at least one of Local Area Network (LAN), a wire harness, an inner bus, a wireless communication line or the like.

The dedicated computer that constitutes the control system 10 may be a planning Electronic Control Unit (ECU) that plans a traveling trajectory as the traveling schedule for the autonomous traveling device 1. The dedicated computer constituting the control system 10 may be a trajectory control ECU that causes the actual trajectory of the autonomous traveling device 1 to follow the target trajectory. The dedicated computer constituting the control system 10 may be an actuator ECU that controls the electric actuators 34 of the autonomous traveling device 1. The dedicated computer constituting the control system 10 may be a sensing ECU that controls the sensor system 5 of the autonomous traveling device 1.

The dedicated computer constituting the control system 10 may be a locator ECU that estimates the self-position of the autonomous traveling device 1 based on the map database 7. The dedicated computer constituting the control system 10 may be a display ECU that controls the information presentation system 8 of the autonomous traveling device 1. The dedicated computer constituting the control system 10 may be at least one external computer that constructs an external center or a mobile terminal capable of communicating via, for example, the communication system 6.

The dedicated computer constituting the control system 10 as shown in FIG. 1 includes at least one memory 11 and at least one processor 12. The memory 11 is, for example, at least one type of non-transitory tangible storage medium, such as a semiconductor memory, a magnetic medium, and an optical medium, for storing, in non-transitory manner, computer readable programs and data. For example, the processor 12 may include, as a core, at least one of a central processing unit (CPU), a graphics processing unit (GPU), a reduced instruction set computer (RISC) CPU, a data flow processor (DFP), a graph streaming processor (GSP), or the like.

In the control system 10, the processor 12 executes multiple commands included in a control program stored in the memory 11 in order to control the autonomous traveling of the autonomous traveling device 1 in the traveling area. Thus, the control system 10 has functional blocks for controlling the autonomous traveling of the autonomous traveling device 1 in the traveling area. The multiple function blocks constructed in the control system 10 include a monitoring block 100 and a control block 110 as shown in FIG. 5.

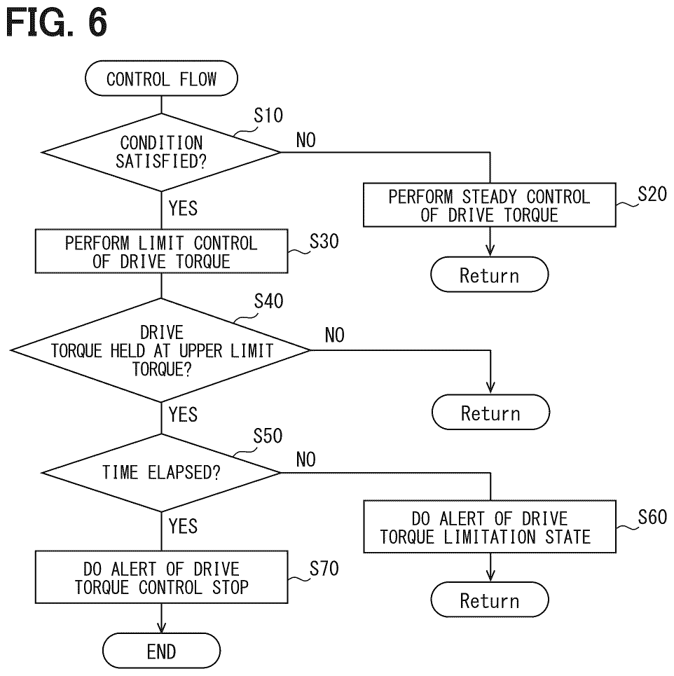

The control method by which the control system 10 controls the autonomous traveling of the autonomous traveling device 1 in the traveling area is executed in cooperation with these blocks 100 and 110 according to the control flow shown in FIG. 6. This control flow is repeatedly executed during startup of the autonomous traveling device 1. In this control flow, each “S” represents a step that is executed in sequence by multiple instructions included in the control program.

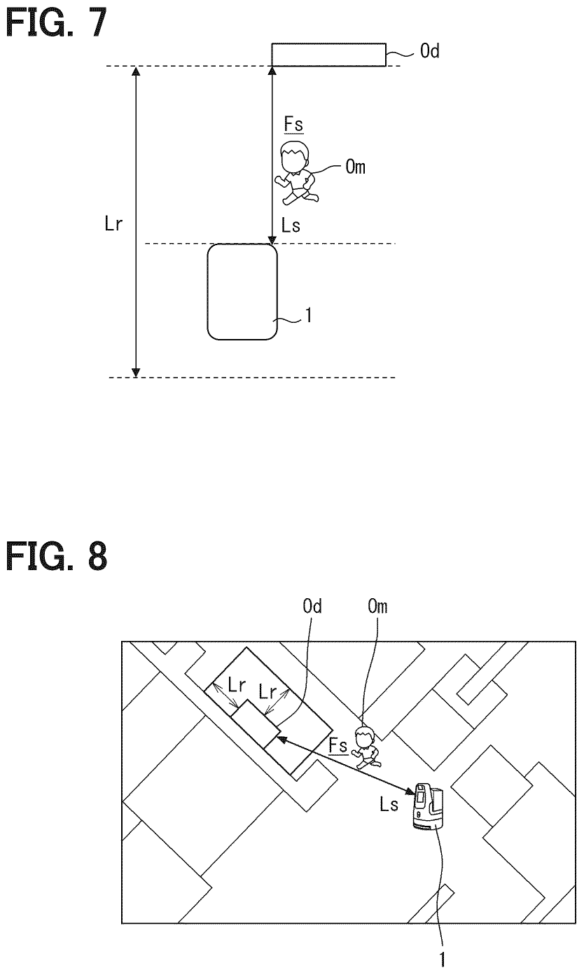

In S10, the monitoring block 100 monitors a risk determination condition Cr for determining the risk assumed for the autonomous traveling device 1 during autonomous traveling in the traveling area. Specifically, the monitoring block 100 in S10 monitors whether the risk determination condition Cr is satisfied regarding an entrapment risk of the autonomous traveling device 1 trapping a nearby monitoring target person Om between itself and an object Od present in the traveling area, as shown in FIGS. 7 to 11. The trapping situation is, for example, a situation where the monitoring target person Om is between the object Od and the autonomous traveling device 1. In other words, the autonomous traveling device 1 forms a situation where the monitoring target person is between the object Od and the autonomous traveling device 1.

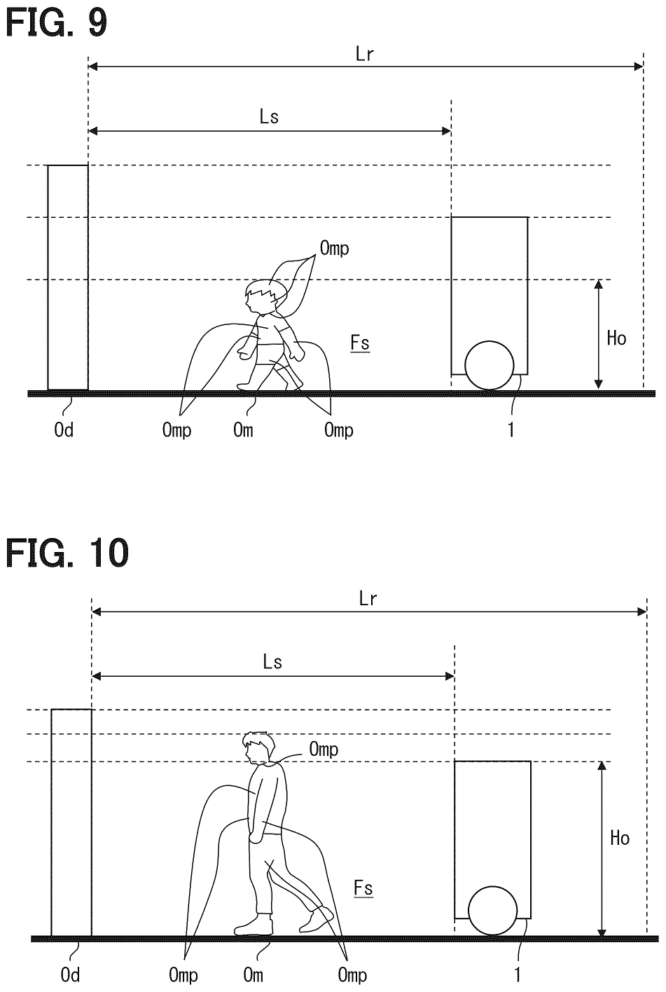

The risk determination condition Cr monitored in S10 is satisfied when the space size Ls in the distance direction of a free space Fs generated between the object Od and the autonomous traveling device 1, as shown in FIGS. 7 to 11, becomes small enough to fall within an expected risk range Lr for the entrapment risk. In this case, as shown in FIGS. 9 to 11, the risk determination condition Cr in the present embodiment is satisfied when the space size Ls within the overlap range Ho in the height direction between the object Od, the autonomous traveling device 1, and the monitoring target person Om is reduced to within the risk range Lr in the distance direction.

In S10 of FIG. 6, of the three elements Od, 1, and Om that constitute the risk determination condition Cr, the object Od is expected to be multiple types that exist in the traveling area of the autonomous traveling device 1, such as, for example, the walls of a building, structures inside and outside the building, and plants inside and outside the building. Therefore, in S10, at least the distance and height size (hereinafter simply referred to as height) are obtained from, for example, distance, position coordinates, size, and shape as object identification information. The object identification information is used for identifying the object Od in three dimensions in the horizontal plane direction, which is the distance direction, and the vertical plane direction, which is the height direction. Such object identification information may be obtained based on at least one of sensing information from the external sensor 50 (in the example of FIG. 2, LIDAR 500, 501 and camera 502), communication information from the communication system 6, and map information from the map database 7.

In S10, of the three elements Od, 1, and Om that make up the risk determination condition Cr, a person present in the traveling area of the autonomous traveling device 1 is assumed to be the monitoring target person Om. Such the monitoring target person Om may be defined as a person located in the free space Fs between the object Od recognized based on the object identification information and the autonomous traveling device 1. Therefore, in S10, as target identification information, at least the position coordinates and height are acquired from among the distance, position coordinates, body height as height, and age and disability level, which affect the risk of entrapment. The information is for identifying the monitoring target person Om in three dimensions in the horizontal plane direction, which is the distance direction, and the vertical plane direction, which is the height direction. Such target identification information may be acquired based on at least one of sensing information from the external sensor 50 (in the example of FIG. 2, LiDAR 500, 501 and camera 502), communication information from the communication system 6, and map information from the map database 7.

In particular, the target identification information acquired by S10 may be acquired by an infrastructure system, such as, for example, an external center, when entering or advancing into the traveling area such as a smart city, smart station, restaurant, hospital, or logistics facility. At this time, the detection information of the monitoring target person Om detected by the infrastructure sensor, or the read information read by the infrastructure sensor from a mobile terminal or card held by the monitoring target person Om, may be stored in the map database 7 directly from the communication system 6 or via the communication system 6, and then acquired as target person information.

In S10, of the two types of establishment criteria that are the risk range Lr and the overlap range Ho for the risk determination condition Cr, the risk range Lr for the space size Ls in the distance direction as shown in FIGS. 7 and 8 is set to a fixed range or a variable range. Here, in the case of the fixed range, the risk range Lr should be preset to a distance range of, for example, 50 cm, which is the maximum safe value of the space size Ls at which the probability of entrapment as the entrapment risk is 100% in the worst-case scenario for which multiple hypotheses can be made in the design. Therefore, in the case of the fixed range, the risk range Lr may be pre-set based on map information in the map database 7, for example, as a distance range in a horizontal plane direction between the closest parts of the object Od and the autonomous traveling device 1 (see FIG. 7), or as a predetermined shape range around the object Od (see FIG. 8). Furthermore, when the risk range Lr is pre-set as the distance range between the closest parts, the risk range Lr may be assumed to start from the object Od as shown in FIG. 7, or may be assumed to start from the autonomous traveling device 1.

On the other hand, in the case of a variable range, the risk range Lr should be set longer in the distance direction from the object Od as the probability of entrapment increases. The entrapment probability indicates the entrapment risk predicted based on, for example, at least one of the target identification information, such as the age, degree of injury, and size of the monitoring target person Om, the speed, acceleration, or size of the autonomous traveling device 1, and the road surface condition, width, traveling separation state, and pedestrian flow situation of the traveling path. At this time, depending on the overlapping part Omp (see FIGS. 9 to 11) of the monitoring target person Om located in the overlap range Ho, a longer risk range Lr may be set in the distance direction from the object Od for the part Omp with a high risk of injury, such as, for example, the head or neck. For these reasons, when setting the risk range Lr in the case of a variable range, it is preferable to use at least one of sensing information from the external sensor 50 (in the example of FIG. 2, LIDAR 500, 501 and camera 502), communication information from the communication system 6, or map information from the map database 7.

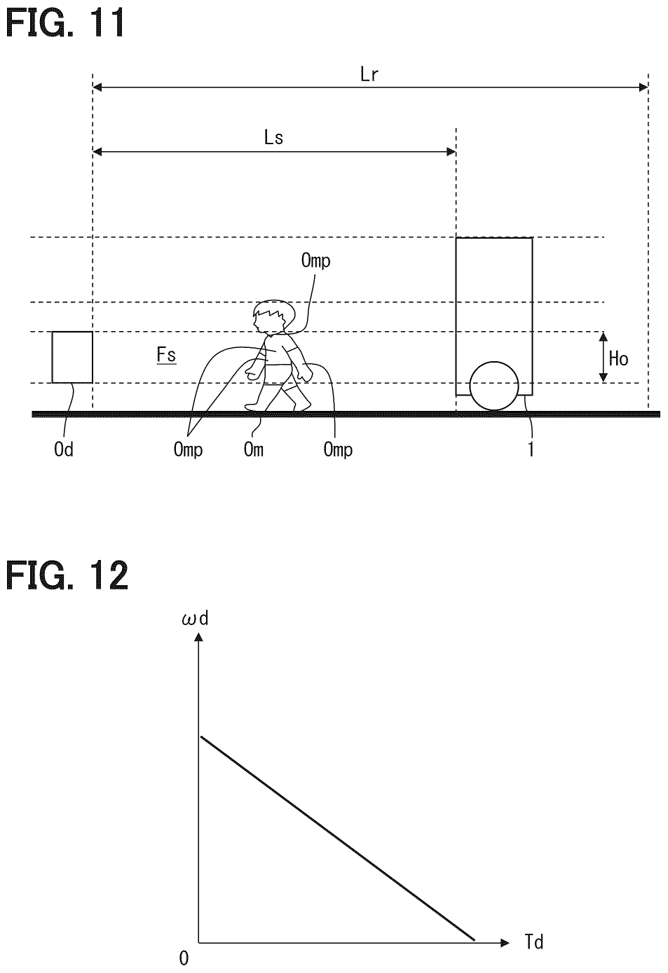

In S10, of the two types of satisfied criteria for the risk determination condition Cr, in the overlap range Ho, three elements Od, 1, and Om that constitute the condition Cr overlap in the height direction as shown in FIGS. 9 to 11. The overlap range Ho is recognized according to the correlation between these three elements Od, 1, and Om. In this case, the upper limit of the overlap range Ho is defined as the height of the lowest element among the three elements Od, 1, and Om. At the same time, the lower limit value of the overlap range Ho is defined as the height of the bottom of the object Od, for example, on a vertical plane passing through the monitoring target person Om between the closest parts of the object Od and the autonomous traveling device 1 (see particularly FIG. 11). Furthermore, the lower limit value of the overlap range Ho may be defined, instead of the height of the bottom of such an object Od, as, for example, the minimum height (approximately 13 centimeters) of the head that is generally expected of a lying-down child among candidates for the monitoring target person Om.

According to these definitions, the overlap range Ho is recognized from, for example, the height of the object Od in the object identification information, the height of the monitoring target person Om in the target identification information, and the height of the autonomous traveling device 1. Therefore, to recognize the overlap range Ho in S10, it is preferable to use at least one of the sensing information from the external sensor 50 (in the example of FIG. 2, LiDAR 500, 501 and camera 502), communication information from the communication system 6, or map information from the map database 7.

When the risk determination condition Cr is not satisfied in S10 (for example, as in the case of FIG. 8), the control flow proceeds to S20 as shown in FIG. 6. In S20, the control block 110 performs steady-state control of the drive torque Td that rotates and drives each drive wheel 300 to cause the autonomous traveling device 1 to travel autonomously. Specifically, in the steady-state control in S20, the drive torque Td output individually from each electric actuator 34 to the corresponding drive wheel 300 is feedback-controlled within a range below the rated torque according to the specifications of each electric actuator 34 as a torque that gives the electric motor 340 a rotational speed wd that correlates with the traveling speed and traveling yaw rate in accordance with the traveling schedule of the autonomous traveling device 1, as shown by a solid line graph in FIG. 12. After the execution of S20 is completed, the control flow returns to S10 as shown in FIG. 6.

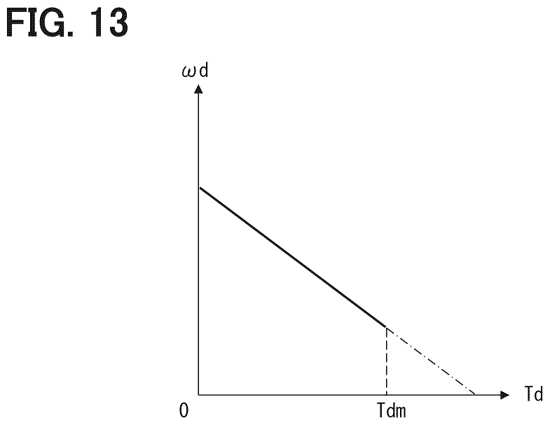

On the other hand, when it is determined in S10 that the risk determination condition Cr is satisfied (for example, in the cases of FIGS. 7, 9 to 11), the control flow proceeds to S30. In S30, the control block 110 performs limit control on the drive torque Td that rotates and drives each drive wheel 300 to cause the autonomous traveling device 1 to travel autonomously. Specifically, in the limit control at S30, an upper limit torque Tdm of the drive torque Td output individually from each electric actuator 34 to the corresponding drive wheel 300 is limited to a value less than the rated torque as shown by a solid line graph in FIG. 13 during feedback control based on the steady-state control shown by a two-dot chain line graph in the same figure.

In S30, the upper limit torque Tdm of the drive torque Td limited by the limiting control is set to a fixed value or a variable value. Here, in the case of the fixed value, the upper limit torque Tdm may be set to the drive torque Td that generates an actuation force of, for example, 250 N (newton) or 400 N in the autonomous traveling device 1 in accordance with ISO 3691-4. In the case of the fixed value, the upper limit torque Tdm may be set to the drive torque Td that causes the autonomous traveling device 1 to generate a maximum allowable force of, for example, 65 N for the face, 150 N for the neck, or 130 N for the head, in accordance with ISO TR23482-1.

On the other hand, in the case of a variable value, the upper limit torque Tdm may be variably set depending on the overlapping part Omp of the body part of the monitoring target person Om that is located within the overlap range Ho in the height direction shown in FIGS. 9 to 11. In this case, in accordance with ISO TR23482-1, the upper limit torque Tdm for the drive torque Td generated by the autonomous traveling device 1 may be set to a single value corresponding to a single overlapping part Omp, or the minimum value of multiple values corresponding to multiple overlapping parts Omp, out of the maximum allowable forces such as, for example, 65 N for the face, 150 N for the neck, 130 N for the head, 160 N for the forearms, 140 N for the chest, 110 N for the abdomen, and 220 N for the thighs.

In the limit control in S30, a limit of the upper limit torque Tdm may be imposed on the drive torque Td for driving the autonomous traveling device 1 in a driving direction in which the risk determination condition Cr is no longer satisfied. In this case, the driving direction in which the risk determination condition Cr is no longer satisfied may be set to the backward direction of the autonomous traveling device 1, for example, when the object Od is present in front of the autonomous traveling device 1.

In the control flow shown in FIG. 6, the process proceeds to S40 after completion of S30, where the control block 110 determines whether the drive torque Td is held at the upper limit torque Tdm by the limit control in S30. When a negative determination is made, the control flow returns to S10. On the other hand, when a positive determination is made, the control flow proceeds to S50.

In S50, the control block 110 determines whether a set time t (for example, 1 second) has elapsed since the most recent process of S40 in which the hold determination of the drive torque Td changed from negative to positive. As the result, when a negative determination is made, the control flow proceeds to S60. In S60, the control block 110 issues an alert that the drive torque Td is being held to the upper limit torque Tdm due to the limit control. At this time, an alert of the hold state may be sent to, for example, an external center or a mobile terminal via the communication system 6. The hold state alert may be given to people in the periphery of the autonomous traveling device 1 by control of the information presentation system 8. After the execution of S60 is completed, the control flow returns to S10.

In the control flow, in S70, which is reached by a positive determination in S50, the control block 110 stops the autonomous traveling control of the autonomous traveling device 1 using the limit control itself as a process corresponding to the passage of the set time t from the start of holding the drive torque Td to the upper limit torque Tdm using the limit control. Therefore, the control block 110 in S70 issues an alert to stop the control of the drive torque Td. At this time, the alert to stop the control may be sent to, for example, the external center or the mobile terminal via the communication system 6. The control stop alert may be issued to people in the periphery of the autonomous traveling device 1 by control of the information presentation system 8. After the execution of S70 is completed, the resumption of execution of the control flow should be prohibited until establishment of the risk determination condition Cr is physically resolved, for example, by the administrator of the autonomous traveling device 1 or a person in the periphery forcing the autonomous traveling device 1 to move.

### Operation and Effects

The operation and effects in the present embodiment described above will be described below.

In the present embodiment, the risk determination condition Cr is monitored to determine the risk of the autonomous traveling device 1 trapping the nearby monitoring target person Om between itself and the object Od present in the traveling area. Therefore, according to this embodiment, when the risk determination condition Cr is satisfied, the drive torque Td for causing the autonomous traveling device 1 to drive autonomously is limited. Thereby, it is possible to grasp, in advance, the entrapment risk due to sudden actions such as the monitoring target person Om entering between the object Od and the autonomous traveling device 1 from the peripheral area, and limit the drive torque Td to the limit torque for preparation for the entrapment risk. Therefore, it is possible to exert risk hedging capabilities against the monitoring target person Om which is human.

The risk determination condition Cr monitored by the present embodiment is satisfied when the space size Ls in the distance direction of the free space Fs generated between the object Od and the autonomous traveling device 1 becomes small to within the expected risk range Lr of the entrapment risk. According to this, even when the space size Ls between the object Od and the autonomous traveling device 1 becomes smaller in the distance direction due to mutual approach in the free space Fs, the drive torque Td can be kept at a limit torque that prepares for the trapping risk identified in advance. Therefore, it is possible to exert risk hedging capabilities for the monitoring target person Om when they are close to each other and there is a high entrapment risk.

The risk determination condition Cr monitored by the present embodiment is satisfied when the space size Ls within the overlap range Ho in the height direction between the object Od, the autonomous traveling device 1, and the monitoring target person Om is reduced to within the risk range Lr in the distance direction. Thereby, it is possible to narrow down the overlap range Ho between the three elements Od, 1, and Om where the entrapment risk can occur in the height direction, and to grasp in advance the increase in the entrapment risk due to the space size Ls between the object Od and the autonomous traveling device 1 due to reduction of the space size Ls in the distance direction. Therefore, it is possible to exert risk hedging capabilities for the monitoring target person Om when they are close to each other within the overlap range Ho where the entrapment risk increases.

In the present embodiment, the overlap part Omp of the monitoring target person Om is located within the overlap range Ho in the height direction where the entrapment risk may occur, and therefore becomes a target part for increased entrapment risk as the space size Ls between the object Od and the autonomous traveling device 1 becomes smaller in the distance direction. Therefore, according to this embodiment, the drive torque Td is limited to the upper limit torque Tdm corresponding to the overlapping part Omp of the body part of the monitoring target person Om that is located within the overlap range Ho in the height direction. Thereby, it is possible to limit the upper limit torque Tdm of the drive torque Td in preparation for the anticipated increased entrapment risk, particularly for the overlap part Omp. Therefore, it is possible to exert risk hedging capabilities for the overlap part Omp of the monitoring target person Om.

According to the present embodiment, when the risk determination condition Cr is satisfied, the drive torque Td for driving the autonomous traveling device 1 in a direction that resolves the condition is limited. Thereby, it is possible to limit the drive torque Td to the limit torque that is prepared for the entrapment risk identified in advance, and at the same time, to lead the autonomous traveling device 1 into a situation in which the entrapment risk of pinching is reduced or mitigated. Therefore, it is possible to improve the risk hedging capability for the monitoring target person Om.

### Other Embodiments

Although the embodiment has been described above, the present disclosure is not to be construed as being limited to the embodiment of the description, and can be applied to various embodiments within the scope not departing from the spirit of the present disclosure.

In another modification, a dedicated computer constituting the control system 10 may include at least one of a digital circuit or an analog circuit, as a processor. The digital circuit is at least one type of, for example, an application specific integrated circuit (i.e., ASIC), an environment programmable gate array (i.e., FPGA), a system on a chip (i.e., SOC), a programmable gate array (i.e., PGA), a complex programmable logic device (i.e., CPLD), or the like. Such a digital circuit may also include a memory in which a program is stored.

In the control flow according to a modification, in S10, whether the risk determination condition Cr is satisfied may be determined based on a comparison between the space size Ls in the distance direction and the risk range Lr, regardless of the overlap range Ho in the height direction. In the control flow according to the modification, S60 may be skipped, and the process may return directly to S10 from the affirmative determination in S40. In the control flow of the modification, S70 may be skipped, and the resumption of execution of the control flow may be prohibited until the establishment of the risk determination condition Cr is physically resolved after the positive determination of S50. In the control flow according to the modification, S40 to S70 may be skipped, and the process may return directly to S10 after the execution of S30 is completed.

In the autonomous traveling device 1 according to the modification, each drive wheel 300 may be configured to be, for example, a Mecanum wheel or an omniwheel, and be capable of switching between straight-ahead driving and turning driving. In addition to the above-described embodiment and modification, the present disclosure may be implemented in forms of a control device that includes at least one processor 12 and at least one memory 11 and is mountable in the autonomous traveling device 1, such as a processing circuit (for example, a processing ECU) or a semiconductor device (for example, a semiconductor chip). Furthermore, the above-described embodiment and modification may be implemented in the form of the autonomous traveling device equipped with such a control device.

What is claimed is:

1. A control system comprising
at least one of (i) a circuit and (ii) a processor with a memory storing computer program code executable by the processor, the at least one of the circuit and the processor configured to cause the control system to:
control autonomous traveling of an autonomous traveling device in a traveling area;
monitor a risk determination condition for determining an entrapment risk that the autonomous traveling device forms a situation where a peripheral monitoring target person is between the autonomous traveling device and an object present in the traveling area; and
limit a drive torque for causing the autonomous traveling device to autonomously travel when the risk determination condition is satisfied.

2. The control system according to claim 1, wherein
monitoring the risk determination condition includes monitoring the risk determination condition that is satisfied when a space size in a distance direction of a free space occurring between the object and the autonomous traveling device becomes small to within an expected risk range of the entrapment risk.

3. The control system according to claim 2, wherein
monitoring the risk determination condition includes monitoring the risk determination condition that is satisfied when the space size within an overlap range in a height direction between the object, the autonomous traveling device, and the monitoring target person becomes smaller to within the expected risk range in the distance direction.

4. The control system according to claim 3, wherein
limiting the drive torque includes limiting the drive torque to an upper limit torque corresponding to an overlap part of a body of the monitoring target person, the overlap part being within the overlap range in the height direction.

5. The control system according to claim 1, wherein
limiting the drive torque includes limiting the drive torque to drive the autonomous traveling device in a direction that resolves the risk determination condition when the risk determination condition is satisfied.

6. The control system according to claim 1, wherein
limiting the drive torque includes issuing an alert that the drive torque is being held due to a limitation when the risk determination condition is satisfied.

7. The control system according to claim 1, wherein
limiting the drive torque includes, when the risk determination condition is satisfied, stopping control of the drive torque depending on elapse of a set time from a start of holding the drive torque by limitation.

8. A control device mountable on an autonomous traveling device, the control device comprising
at least one of (i) a circuit and (ii) a processor with a memory storing computer program code executable by the processor, the at least one of the circuit and the processor configured to cause the control device to:
control autonomous traveling in a traveling area of the autonomous traveling device;
monitor a risk determination condition for determining an entrapment risk that the autonomous traveling device forms a situation where a peripheral monitoring target person is between the autonomous traveling device and an object present in the traveling area; and
limit a drive torque for causing the autonomous traveling device to autonomously travel when the risk determination condition is satisfied.

9. A control method executed by a processor and comprising:
controlling autonomous traveling of an autonomous traveling device in a traveling area;
monitoring a risk determination condition for determining an entrapment risk that the autonomous traveling device forms a situation where a peripheral monitoring target person is between the autonomous traveling device and an object present in the traveling area; and
limiting a drive torque for causing the autonomous traveling device to autonomously travel when the risk determination condition is satisfied.

10. A non-transitory computer-readable storage medium storing a control program including instructions causing a processor to:
control autonomous traveling of an autonomous traveling device in a traveling area;
monitor a risk determination condition for determining an entrapment risk that the autonomous traveling device forms a situation where a peripheral monitoring target person is between the autonomous traveling device and an object present in the traveling area; and
limit a drive torque for causing the autonomous traveling device to autonomously travel when the risk determination condition is satisfied.

11. An autonomous traveling device equipped with the control device according to claim 8.
